(19) United States
(12) Patent Application Publication
(10) Pub. No.: US 2004/0103587 A1
(43) Pub. Date: Jun. 3, 2004

(54) ACCESS DOOR

(76) Inventors: Dennis V. Fletcher, Elkhart, IN (US); Thomas W. Kleckner, Plymouth, IN (US); Nikola S. Hromis, Granger, IN (US); John W. Lewis JR., Goshen, IN (US); Steven D. Saffell, Mishawaka, IN (US); Kenneth T. Waggoner, Niles, MI (US)

Correspondence Address: CALFEE HALTER & GRISWOLD, LLP, 800 SUPERIOR AVENUE, SUITE 1400, CLEVELAND, OH, 44114, US

(21) Appl. No.: 10/605,153

(22) Filed: Sep. 11, 2003

Related U.S. Application Data
(60) Provisional application No. 60/409,763, filed on Sep. 11, 2002.

(51) Int. Cl. E05D 7/00

(52) U.S. Cl. 49/402

(57) ABSTRACT

An access door is provided which may be easily installed. The door utilizes a mounting tape which is affixed between the door frame and the surface which supports the door as well as acting as a seal. The mounting tape allows installation by a single individual. The door may be further held in position by a minimal number of screws after being attached initially using the mounting tape. A core surround member may also be part of the door. The core surround covers a gap between the door and the door frame from view.

This application claims the benefit of U.S. provisional patent application No. 60/409,763 filed on Sep. 11, 2002 the entirety of which is hereby incorporated by reference.

### BACKGROUND OF INVENTION

The present invention concerns a door apparatus used in conjunction with horse trailers, utility trailers and/or recreational vehicles. Typical doors used in these applications employ common attachment means, namely a large number of screws which extend into a jamb around the opening in a wall or other surface. This common type of door takes a long period of time to install due to the amount of screws involved. Additionally a number of the screw heads are visible after installation.

Alternatively, a clamp ring is used for installation of the door. With this method the door is placed in the rough opening of the wall and held in place by one individual while another installs a mounting device from the interior using screws that go through the clamp ring into the jambs of the door. As the screws are drawn tight the unit sandwiches the wall locking it in place. Use of either of these known apparatus also requires caulking around the edge of the door to provide a seal between the door and the wall or surface into which the door is mounted.

An improved door apparatus is desired which uses fewer screws, thus reducing installation time and can be installed by a single individual. In addition, the presence of the screws should not be obvious after installation. Finally, there should be no need to caulk the door after installation is complete.

### SUMMARY OF INVENTION

The present apparatus and method overcomes the shortcomings in the prior art. The present door minimizes the need for screw installation and caulk sealing. The installation may be made directly through the door jamb, without the use of a clamp ring. The door provides a flush appearance with the rest of the compartment enclosed by the door. Additionally there is no visible gap between the door core and door mainframe.

The design of the door frame is such that it does not have a blind stop for core and it hugs the rough opening of the mounting surface. The door frame is designed so that no additional protrusions extend into the clear opening other than what is required. The blind stop for an optional cage is only applied at the lock side of the frame and only when a cage is present. This results in a gain of close to 2.54 centimeters (1 inch) width and 1.27 centimeters (0.5 inch)″ to 2.54 centimeters (1 inch) in height over traditional configurations.

In one version a vehicle door assembly, easily attachable to a door jamb, is provided which includes a peripheral frame attachable to the door jamb, a door member movable on hinges between a closed position within the peripheral frame and an open position, and mounting tape affixed between the peripheral frame and door jamb to hold said peripheral frame in place and to seal spaces between the peripheral frame and the door jamb.

In another version a vehicle door assembly providing a gap-free appearance is provided which includes a peripheral frame, a door member movable on hinges between a closed position within the peripheral frame and an open position, and a core surround affixed to said door member, said core surround covering a gap between said door member and peripheral frame when said door member is in a closed position.

These and other versions of the invention are described in more detail within the following description and drawings.

### BRIEF DESCRIPTION OF DRAWINGS

FIG. 1a is a front view of a first embodiment of the door;

FIG. 1b is a front view of a second embodiment of the door;

FIG. 1c is a front view of a third embodiment of the door;

FIG. 1d is a front view of a fourth embodiment of the door;

FIG. 2 is a first cutaway view of the door;

FIG. 3 is a second cutaway view of the door;

FIG. 4 is a detailed view of the core surround;

FIG. 5 is a detailed view of the core surround and seal;

FIG. 6a is a detailed view of the hinge;

FIG. 6b is a detailed view of the main hinge;

FIG. 7a is a cutaway view of a frame splice plate;

FIG. 7b is a side view of two spliced frame members;

FIG. 7c is a cutaway view of a frame member and splice plate;

FIG. 8 is a cutaway view of the core surround;

FIG. 9 is a horizontal cutaway view of an alternative embodiment of the door including a cage;

FIG. 10 is a vertical cutaway view of an alternative embodiment of the door including a cage;

FIG. 11 is a cutaway view of a hinge leaf used with a cage system.

### DETAILED DESCRIPTION

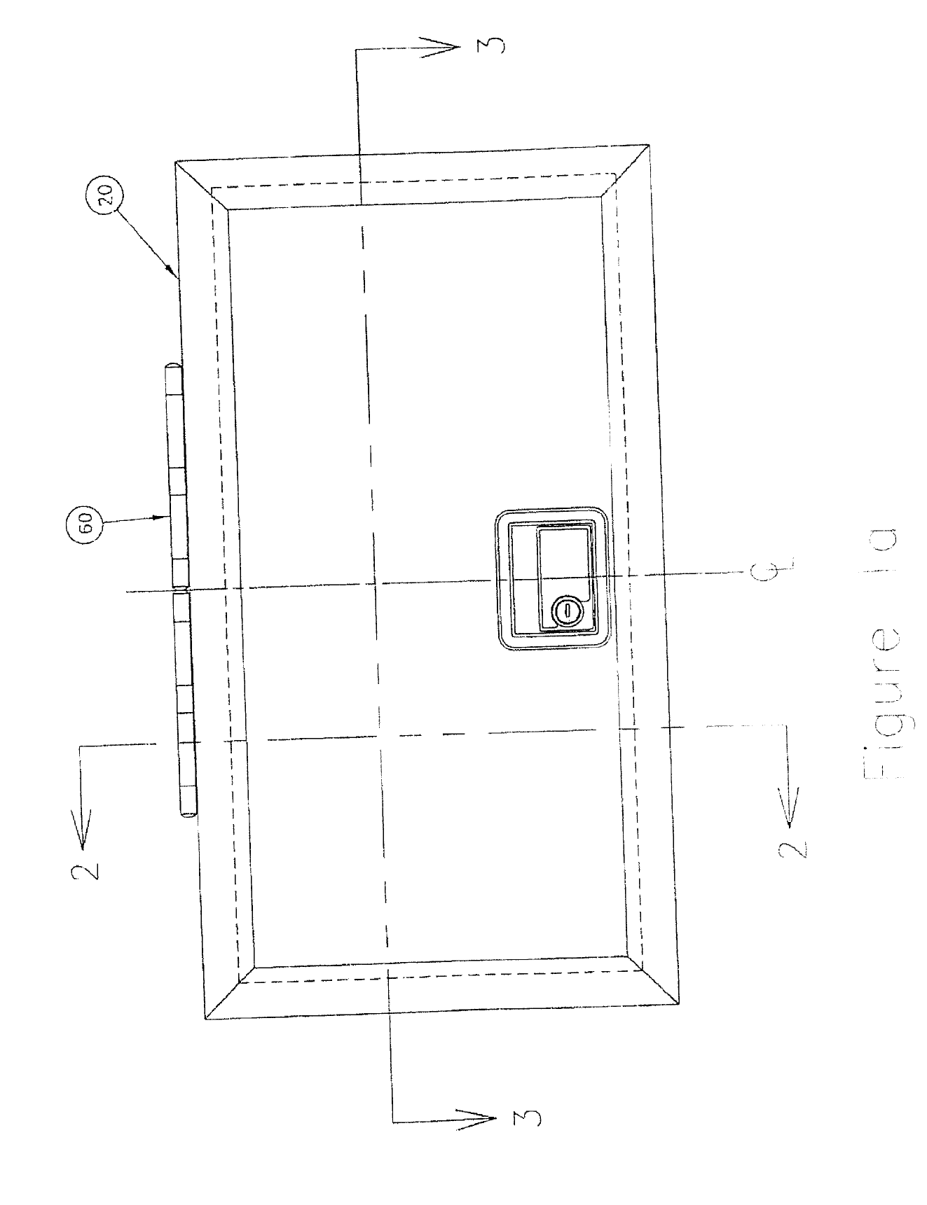

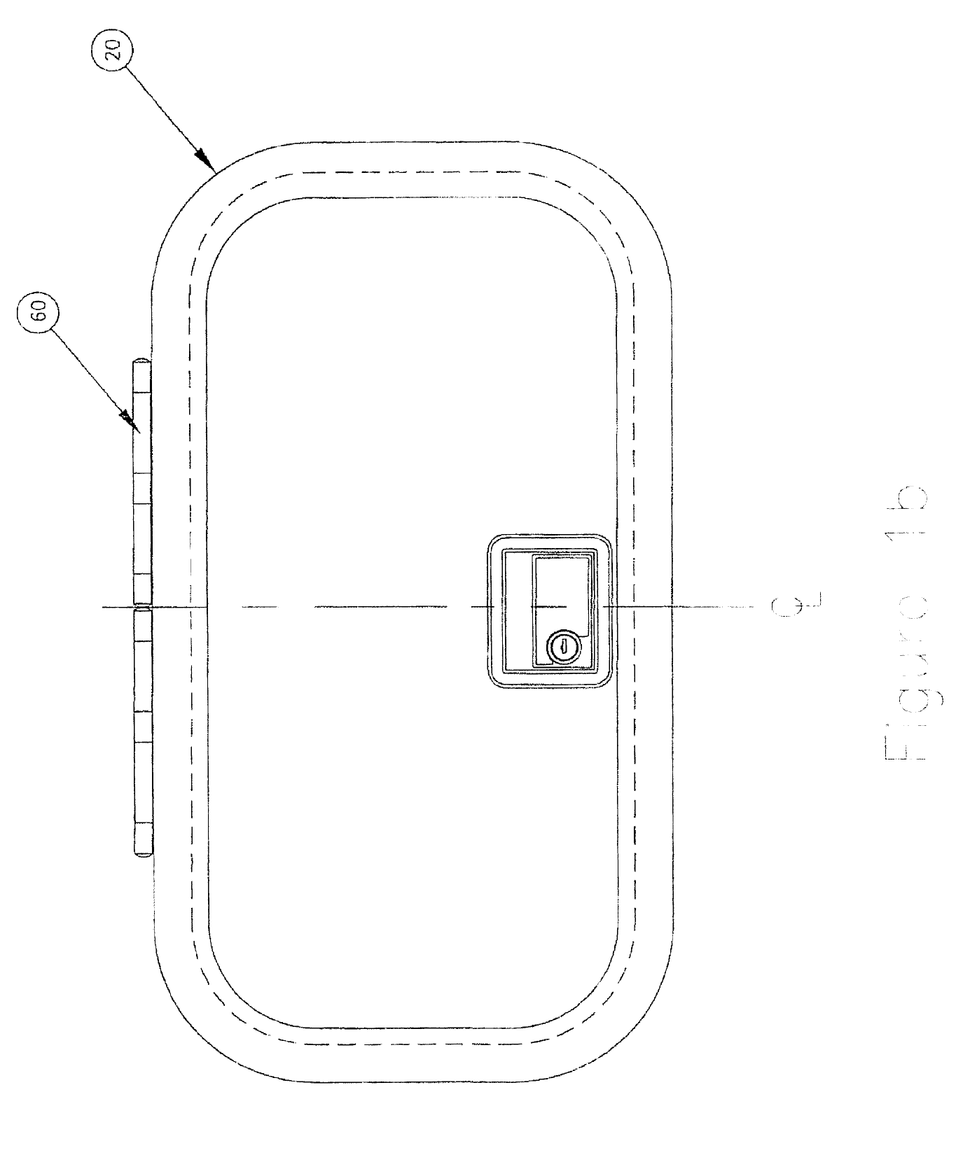

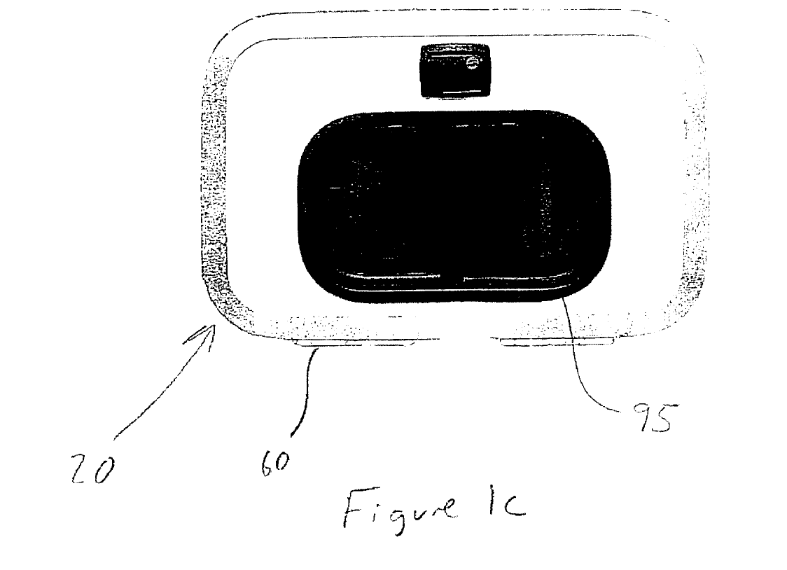

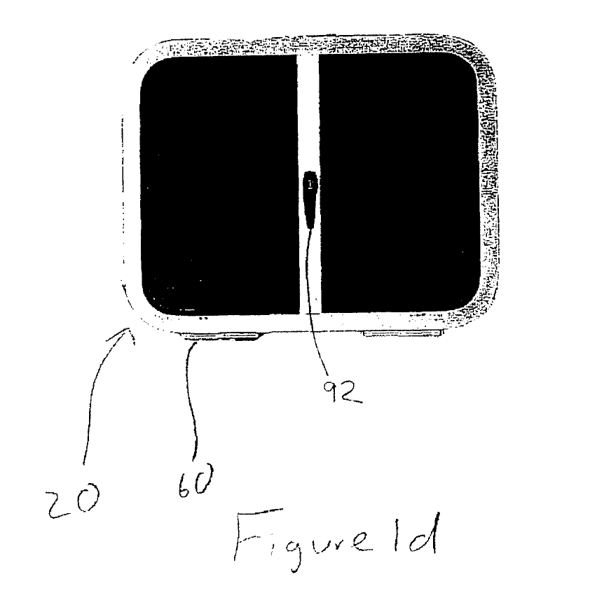

As described in more detail below and shown in FIGS. 1-3, a door 20 is provided which includes a frame 30, core 40, core surround 50, skin 42, and hinges 60. The door 20 may be provided in either a square edge configuration shown in FIG. 1a or round edge configuration shown in FIG. 1b. FIGS. 1c and 1d show additional “Feed Door”embodiments. These embodiments may include windows and/or doors within the core, varied types and positions of handles for opening the access door and cage systems.

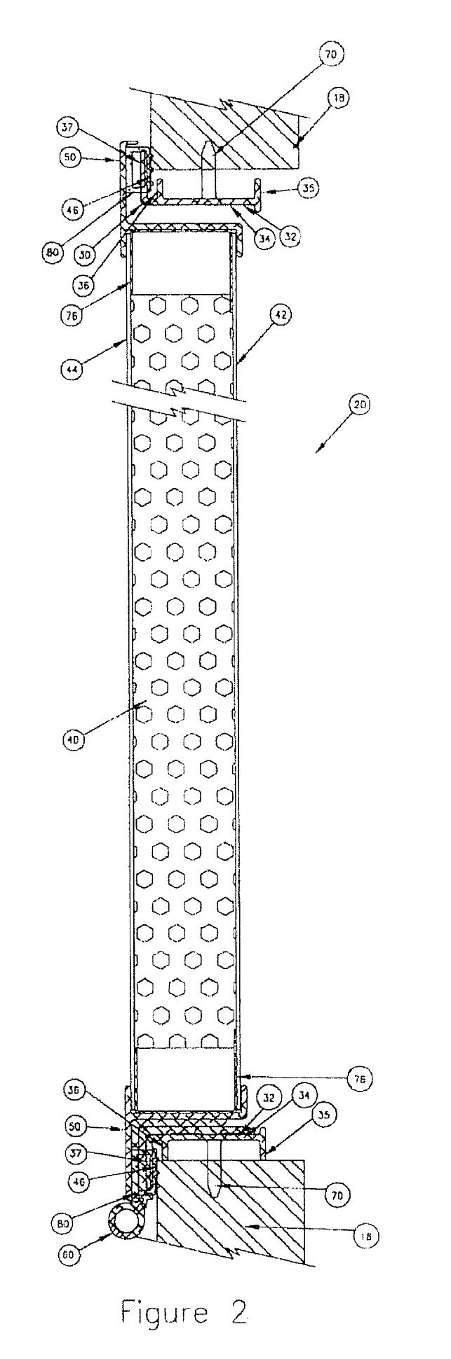

Referring to FIG. 2, the door 20 includes a frame 30 which is placed within an open passage defined by one or a series of door jambs 18. The frame 30 is screwed into the jamb 18 with a minimum number of screws. Chart 1 shows the typical number of screws used to attach the frame. This number is fewer than typical doors because of the mounting tape used to hold the door in place as described below. The frame 30 is made of a number of frame members 32.

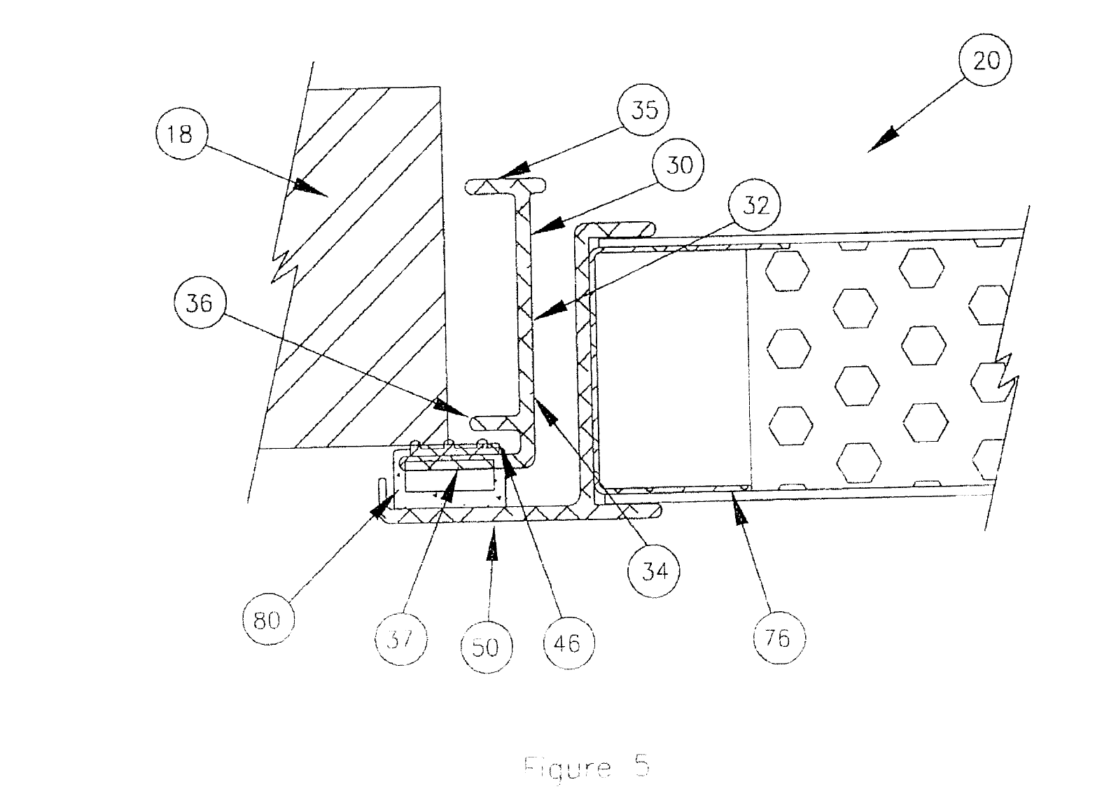

Each frame member 32 may be an aluminum extrusion. The frame member 32 may include a base 34 and a plurality of legs. In a preferred embodiment of the frame member 32, three legs 35-37 are included. Referring to FIG. 5, a first exterior leg 35 may extend from one side of the base 34. A second leg 36, considered an interior leg, extends in the same direction as the majority of the first leg 35 and may have a generally equivalent length in that direction compared to the first leg 35. A third leg 37, considered an exterior leg, is located at the opposite side of the base 34 and extends in the same direction as the first 35 and second legs 36. The third leg 37 may be longer than the first 35 and second legs 36. The interior leg 36 is located between the first 35 and third legs 37, both considered exterior legs. In an alternate embodiment of the invention the frame member 32 does not include leg 36.

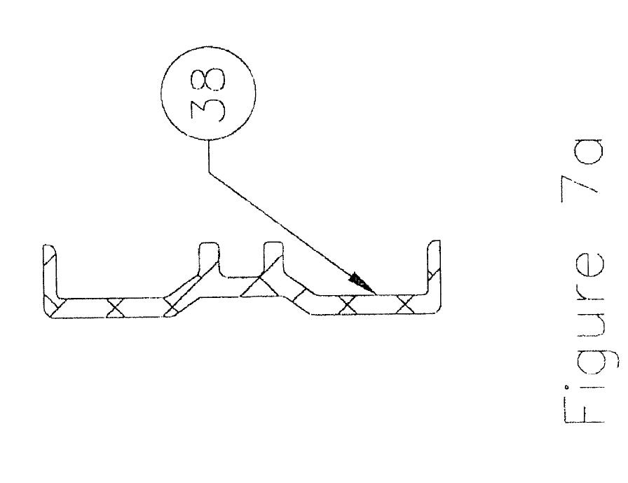

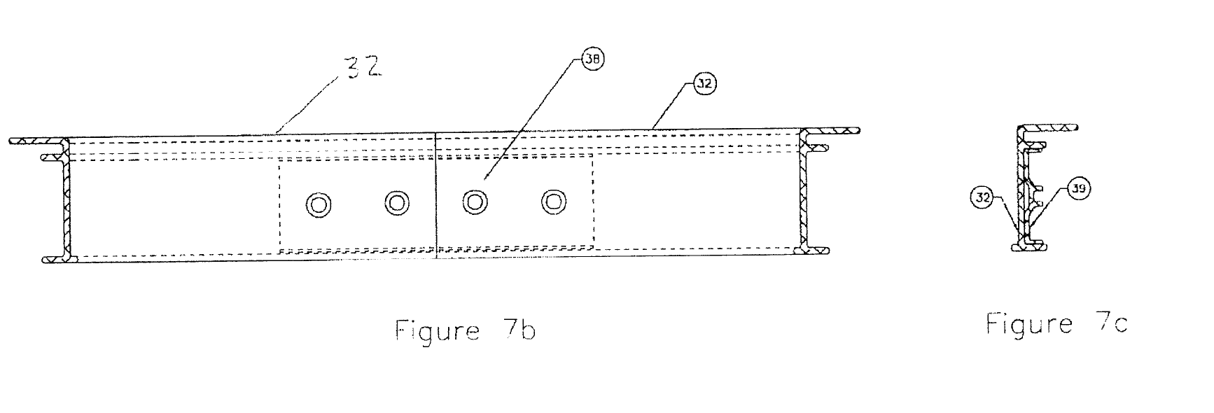

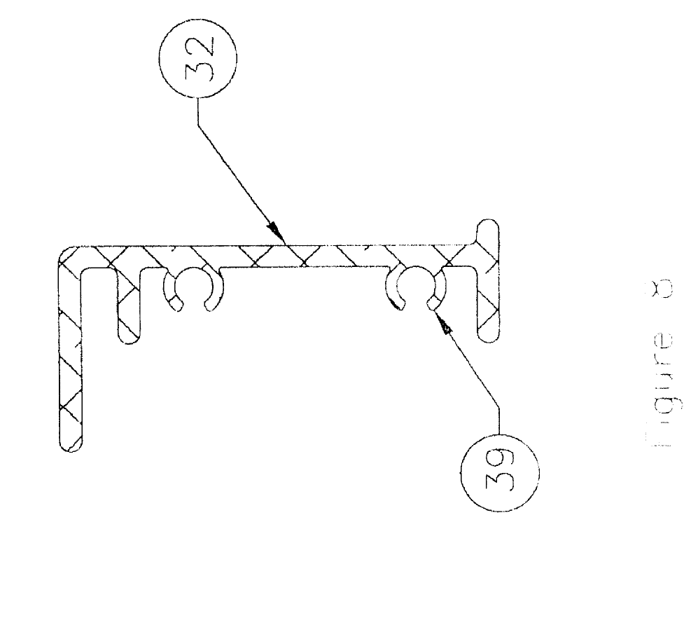

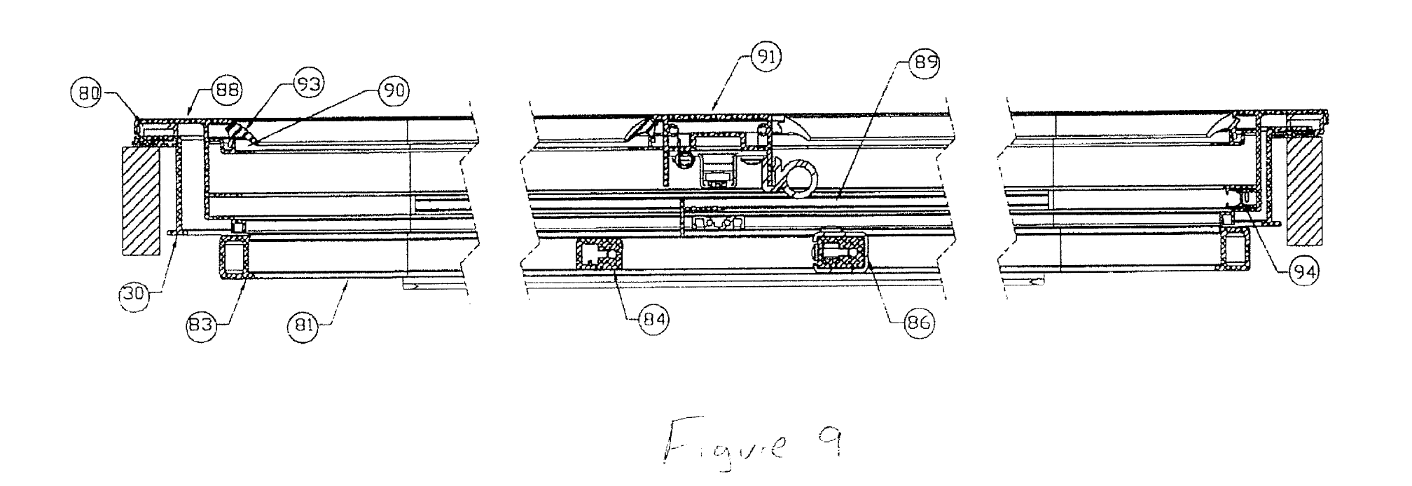

The extra length of the third leg 37 allows the frame 30 to overlap the door jamb 18, thus providing a more aesthetic appearance. The frame members 32 are preferably made from extruded aluminum, although other materials such as steel or plastic may be used. The frame 30 functions both as a support for the door 20 and as means to cover the door jamb 18 and any other interior components of the wall or surface to which the door 20 is applied. Referring to FIGS. 7a-c, multiple frame members 32 may be joined together using a splicing piece 38. Referring to FIG. 8, the frame member 32 may also include one or more screw bosses 39 as part of the extrusion for the passage of mounting screws 70. Screw bosses 39 may be used in rectangular embodiments of the frame 30. Referring back to FIG. 2 the frame members 32 are oriented such that the three legs 35-37 point towards door jamb sections 18. The two shorter legs 35-36 may abut the jamb while the third leg 37, which is longer, may overlap the exterior side of the jamb 18. Additional apertures may be included in the frame 32 for the passage of a handle latch and screws for mounting the hinges.

Caulk and screws used in traditional doors may be replaced by the use of a two sided tape 46 between the frame 30 and door jamb 18. Referring to FIG. 5, tape 46 may be applied to the frame member 32 and then, as the door 20 is installed, affixed to the jamb 18 or a member of the structure adjacent to the jamb 18. Preferably the tape 46 is applied to all four sides of the door frame 30. The tape 46 allows the door 20 to be installed by a single individual. Once pressed in place the door 20 is effectively installed and can be operated when supported solely by the tape 46. However, it is preferred that additional screws are used for greater structural integrity.

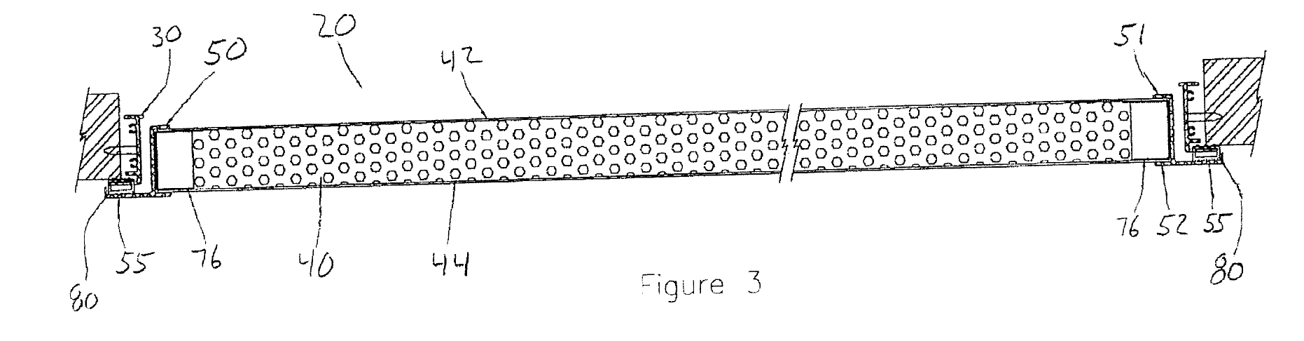

Referring to FIGS. 2 and 3, the door includes a core 40 which is sandwiched by two skins 42 and 44. The core 40 has a general rectangular shape and may be manufactured from an expanded polystyrene (EPS) foam. As a substitute an injected foam may be used in place of EPS. The core 40 is sized according to the preferred size of the overall door 20. The core 40 is sandwiched by skins 42 and 44 which may be flat sheets having a rectangular shape. The skins 42 and 44 are typically oversized in comparison to the core 40, thus the core 40 is not visible when the door 20 is observed head on or from behind. The skins 42 and 44 are preferably manufactured from a smooth aluminum which in turn may be painted. The skins 42 and 44 may also be manufactured from fiberglass. The door may include one fiberglass skin and one aluminum skin. The core may be surrounded around its edges by a steel stile 76. The core 40 may extend to the end of the stile 76 or there may be a gap between the stile 76 and core 40. Multiple stile pieces 76 may be spliced together. The skins 42 and 44 may be hot melt laminated to the core 40.

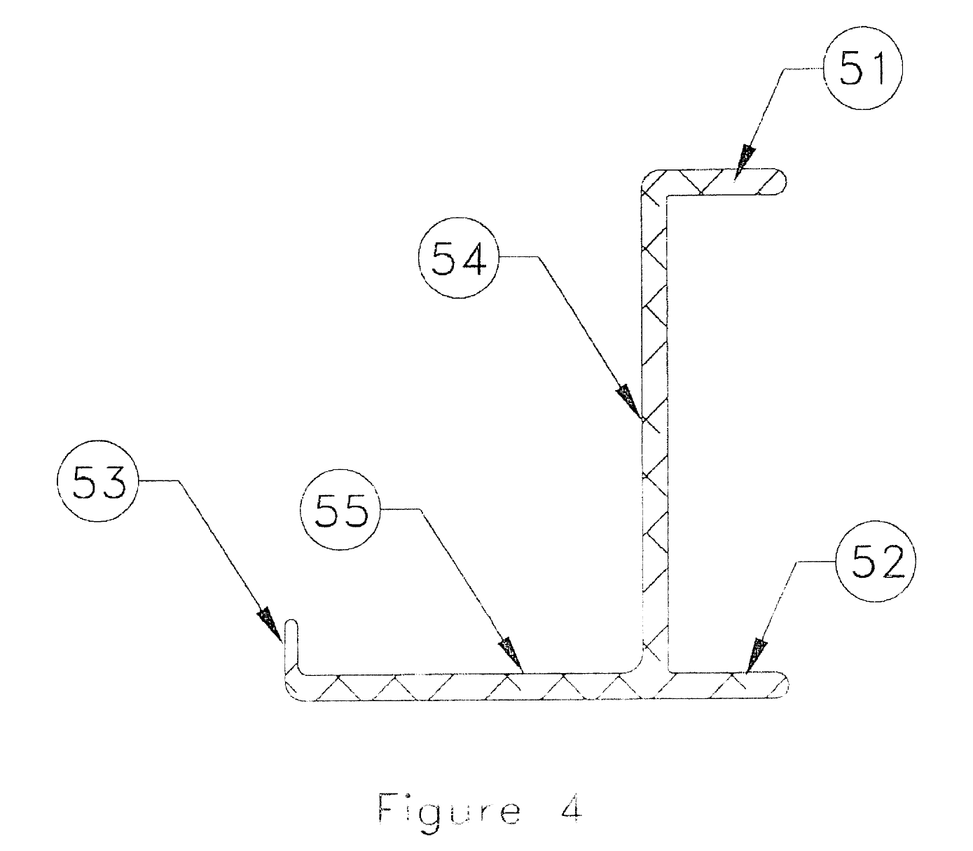

The sides of the core 40 are shielded from view by a number of core surrounds 50. The core surrounds 50 serve a second purpose of covering the gap between the core 40 and skin 42 and 44 combination and the frame 30 of the door 20. Referring to FIG. 4, in a preferred embodiment of the door 20 the core surround 50 has and “L” shape with a leg protruding from each end or corner of the “L”. The two portions 54 and 55 of the core surround 50 forming the “L”are generally perpendicular to each other. The leg 51 at the uppermost end of the “L” extends outward perpendicularly from the uppermost portion 54 and in a direction opposite from the lowermost portion 55 of the “L”. The second leg 52 extends in the same direction as the first leg 51 and from the corner of the “L”. The third leg 53 extends in a direction generally parallel to the uppermost portion 54 of the “L”. Preferably the core surround 50 is also formed from extruded aluminum. Referring to FIG. 3, the two legs 51 and 52 which point in the same direction are oriented to go over the side of the core 40 and skin 42 and 44 combination or stile 76 and as a result the core 40 or stile 76 is hidden from plain view. The lowermost portion 55 of the “L”extends to cover the gap between the door core 40 and skins 42 and 44 and the frame portion 30 of the door 20 when the door 20 is in a closed position. The core surround 50 may also include one or more screw bosses as part of the extrusion for the passage of mounting screws.

Referring to FIG. 5, a seal 80 is provided between the core surround 50 and the frame 30 of the door 20. The seal 80 preferably has a bulb shape, and thus provides a cushion as the door 20 is closed. The seal 80 is formed of a polymer such as Ethylene Propylene Terpolymer (EPDM) which is generally flexible. Preferably, the seal 80 extends around all four sides of the door 20. The seal 20 functions to prevent the migration of air, moisture or fluids through the door 20 when the door 20 is in a closed position. The seal 80 is affixed to the interior surface of the lowermost “L”portion 55 of the core surround 50. The seal 80 has a width which is less that the width of the lowermost “L”portion 55 of the core surround 50, thus the seal 80 is not visible when the door 20 is viewed head-on. The seal 80 may be an elongated member which extends along the full perimeter of all four sides of the door 20. Alternatively, the seal 80 may consist of more that one individual member, each having the same shape. The seal 80 is configured in a way such that a flat section of the bulb shape abuts the surface of the core surround 50. An arcuate portion of the seal 80 is designed to contact the frame 30, and to be compressed in the process. The seal 80 may be affixed to the core surround 50 using tape.

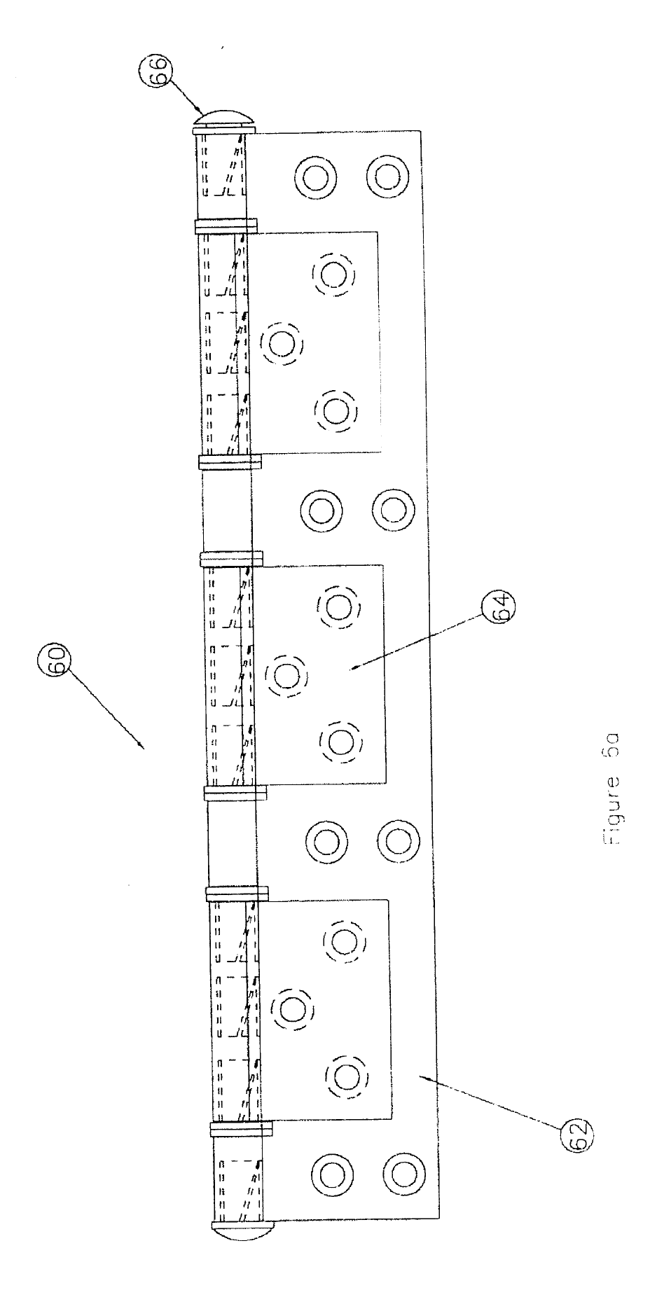

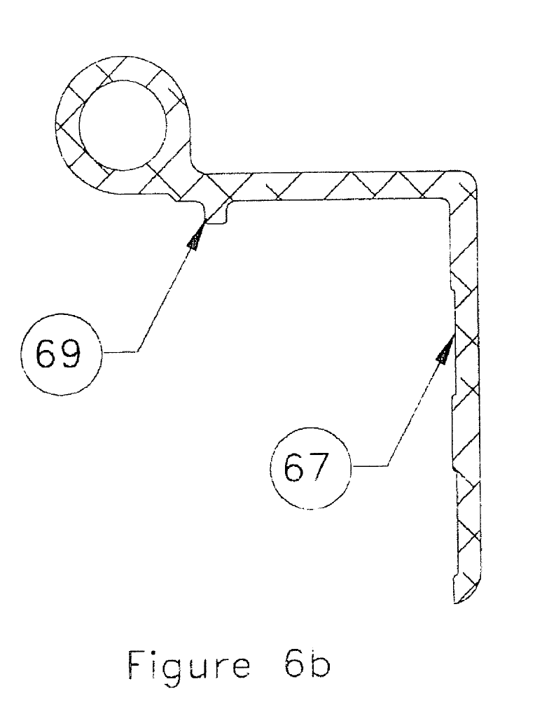

Referring to FIGS. 2, 6a and 6b, one or more hinges 60 are attached to both the core surround 50 and a frame member 32, allowing the door core 40 and skins 42 and 44 to be rotated between an open and closed position. Each individual hinge 60 includes a main hinge 62 which may be affixed to the frame 30 and one or more leaf hinges 64 which may be attached to the core surround 50. The main hinge 62 and leaf hinge(s) 64 are held together using a hinge pin 66. Washers 68 may be provided between points of contact to minimize friction and wear upon the hinges 60.Referring to FIG. 6a a typical hinge 60 is shown having three leaf hinges 64. FIG. 6b shows a main hinge 62 having areas of reduced thickness 67 and a stop portion 69.

Referring to FIG. 1c an embodiment including a window 95 is shown. The window opening is generally cut into the door core by a router and the window 95 is then dropped into place. The window 95 uses a clamp ring to hold it in place.

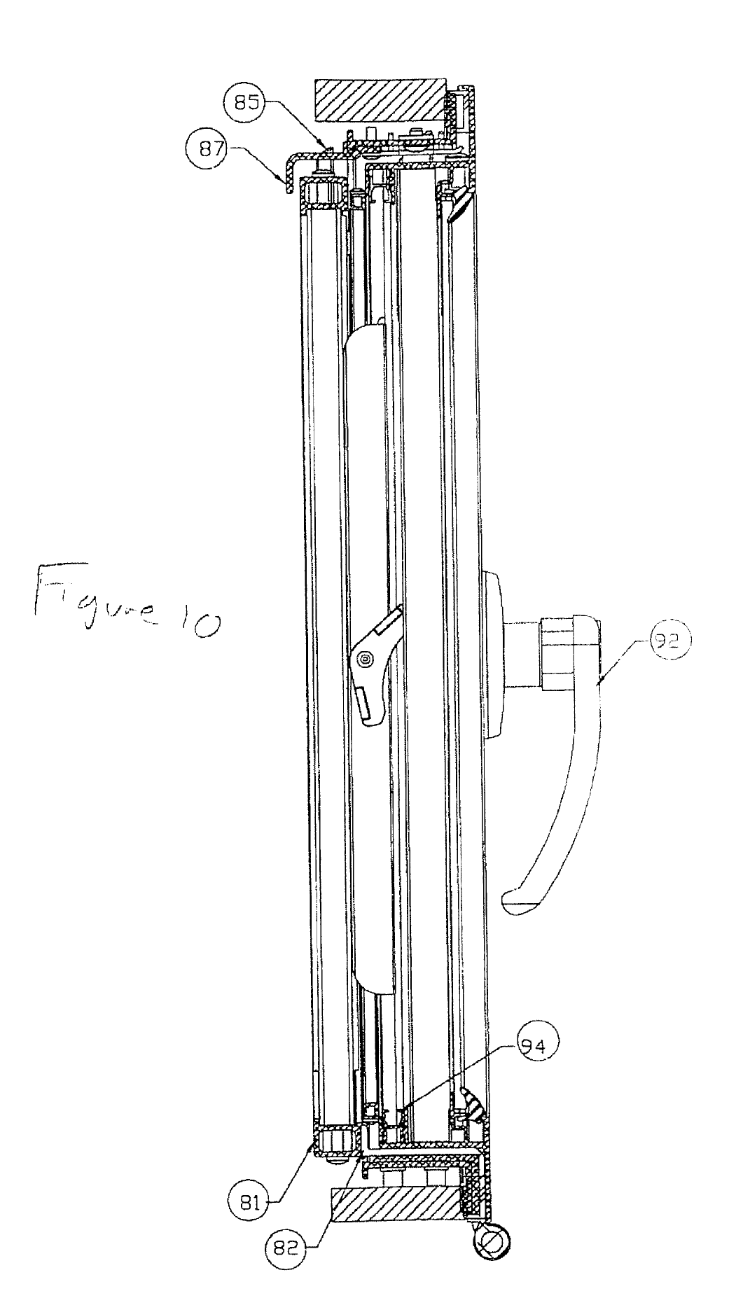

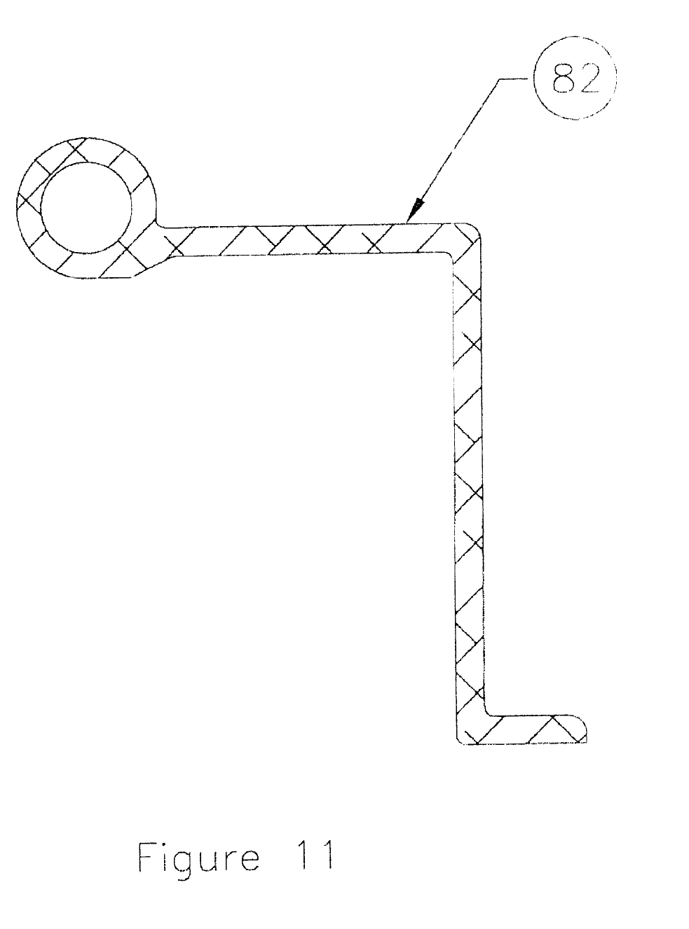

FIGS. 9 and 10 shows an embodiment including a cage system 81. The cage system 81 consists of an outer extruded aluminum tubular frame 83 that is generally rectangular in shape with rounded corners. The size of the cage system 81 is dictated by the size of door. Running vertically within the outer frame are a series of rectangular bars 84. Spacing is such that an animal can not push their head out of the unit when the cage system 81 is in the closed position. The cage system 81 is held in the closed position by the hinges on one side and a spring loaded bolt 85 on the other. The bolt 85 is mounted internal of the cage bar with an external trip mechanism. The bolt 85 is always in the closed position unless a force is applied to the trip mechanism of the bolt to retract it. The force could be applied to a pull wire or to a tubular handle 86 that wraps the vertical bar. The cage system 81 is prevented from over-rotating by a blind-stop 87 that is applied to the lip of the frame 30. This door with cage system 81 is available in both square and radius configurations but the cage system 81 always has radiused corners so as not to injure the animals. The cage system 81 uses an alternate hinge configuration that substitutes one of the door leaf components with a revised version that will mate to the cage system 81. The cage system 81 can open and close with the core or can be left in a closed position when the core is opened to prevent an animal from pushing it's head out the opening. With the core in the open position the cage system can be opened and closed independently.

FIG. 1d, 9 and 10 shows an embodiment which uses a modified version of the core surround 50 with sliding 89 and fixed glass panels 90 and a center mullion 91 that incorporates a handle 92 with a remote trip bolt. The benefit of this design is a large area of glazing that allows for maximum lite and a center handle 92 that allows better control of the door when opening and closing the unit. The core surround is similar in design to that previously described, but adds a series of legs that act as tracks for the operable glass and mounting surfaces for the fixed glass. The fixed glass is glazed in place with tape or wet glazing and a glazing bead 93 is used to dress out the final appearance. The operable panels ride on plastic inserts 94 that aid in operation of the glass panel and prevent metal to glass contact and rattling of the glass. The operable panel can be opened or closed and locked in the closed position by a locking handle. The mullion acts as a support for the fixed glass and a mounting for the handle 92. With this design the handle 92 is located generally near the center of the door and allows for better control of the door when opening and closing. Additionally it lowers the handle from traditional locations so that it is more assessable to people of shorter stature. The center location is made possible by the use of an external handle that is linked to an internal cam and cable that when operated trips a slide bolt at the edge of the door. Additionally the design allows for a clean streamlined look. This embodiment is formed in the radius corner versions only.

Additional components necessary for the operation of a door are also included as part of the invention such as a handle latch upon the core and skins portion and corresponding latch plate upon the frame. The handle may include a lock.

Although the invention has been shown and described with reference to certain preferred and alternate embodiments, the invention is not limited to these specific embodiments. Minor variations and insubstantial differences in the various combinations of materials and methods of application may occur to those of ordinary skill in the art while remaining within the scope of the invention as claimed and equivalents. Use of the term “or”herein is the inclusive, and not the exclusive use.

1. A door assembly providing a gap-free appearance comprising:
a peripheral frame;
a door member movable on hinges between a closed position within the peripheral frame and an open position; and
a core surround affixed to said door member, said core surround covering a gap between said door member and peripheral frame when said door member is in a closed position.

2. The door assembly of claim 1 wherein said door member includes a core and at least one skin enclosing said core.

3. The door assembly of claim 1 wherein said door member is attached to said peripheral frame by said hinges.

4. The door assembly of claim 1 wherein said core surround includes two perpendicular members affixed together in an “L-shaped”configuration, the first member affixed to said door member and the second member covering the gap between the door member and peripheral frame.

5. The door assembly of claim 4 wherein said core surround includes a leg extending from each corner of its “L-shaped”configuration.

6. The door assembly of claim 4 wherein a seal is attached to the second member of the core surround.

7. A door assembly easily attachable to a door jamb comprising a peripheral frame attachable to the door jamb;
a door member movable on hinges between a closed position within the peripheral frame and an open position; and
mounting tape engaged between said frame and the door jamb to position said peripheral frame in place and to seal spaces between the peripheral frame and a door jamb.

8. The door assembly of claim 7 wherein said peripheral frame is attachable to a door jamb using no more than six screws.

9. The door assembly of claim 7 wherein said peripheral frame is attachable to a door jamb using no more than twenty screws.

10. The door assembly of claim 7 further including a core surround affixed to said door member, said core surround covering a gap between said door member and peripheral frame when said door member is in a closed position.

11. The door assembly of claim 7 further including a cage system movable on hinges between a closed position and an open position.

12. The door assembly of claim 7 wherein said door member includes a window therein.

13. A method of affixing an access door to a structure comprising the steps of:
a. affixing a peripheral frame directly to a door jamb within the structure using mounting tape;
b. affixing a hinge to said peripheral frame and to a door member wherein said door member is movable on said hinges between a closed position within the peripheral frame and an open position.
